(19) United States
(12) Patent Application Publication
(10) Pub. No.: US 2026/0367693 A1
(43) Pub. Date: Nov. 19, 2026

(54) MODIFICATION OF A CONDITION FOR A STATE MACHINE TRANSITION

(71) Applicant: Texas Instruments Incorporated, Dallas, TX (US)

(72) Inventors: Aniruddha Periyapatna Nagendra, Bangalore (IN); Anand Kumar G, Bangalore (IN)

(21) Appl. No.: 19/210,822

(22) Filed: May 16, 2025

(51) Int. Cl. G06F 1/3287; G06F 1/3206; G06F 9/448

(52) U.S. Cl. CPC G06F 1/3287; G06F 1/3206; G06F 9/4498

(57) ABSTRACT

Methods, apparatus, systems, and articles of manufacture are described for a modification of a condition for a state machine transition. An example device includes a first circuit configurable to transition from a first state to a second state when a first signal is asserted; and a second circuit configurable to modify a condition of the transition from the first state to the second state in the second circuit based on a command received from an interface.

### TECHNICAL FIELD

This description relates generally to circuits, and, more particularly, to modification of a condition for a state machine transition.

### BACKGROUND

An electrical device, such as a system-on-a-chip (SoC), a semiconductor device, an integrated circuit, etc. may include a state machine that controls the power of the device by managing transitions between different power states to balance performance and energy efficiency. The state machine can monitor inputs such as processor activity, peripheral usage, and thermal conditions to determine when to enter low-power modes like sleep or idle, or when to wake components up for operation. Each state represents a specific configuration of powered-up and powered-down subsystems, with well-defined transitions ensuring smooth and safe state changes. By coordinating voltage and clock gating, these state machines enable fine-grained power management across the SoC, reducing overall energy consumption while maintaining system responsiveness.

### SUMMARY

For a modification of a condition for a state machine transition, an example device includes a first circuit configurable to transition from a first state to a second state when a first signal is asserted; and a second circuit configurable to modify a condition of the transition from the first state to the second state in the second circuit based on a command received from an interface. Other examples are described.

For a modification of a condition for a state machine transition, an example device includes a first circuit configurable to transition from a first state to a second state based on an occurrence of a first event; and a second circuit configurable to, based on a value stored in a register: determine an occurrence of a second event different from the first event; and cause the first circuit to transition from the first state to the second state based on the occurrence of the second event. Other examples are described.

For a modification of a condition for a state machine transition, an example system includes a first circuit configurable to: access (a) a first value for transitioning from a first state to a second state based on a first event and (b) a second value for transitioning from the second state to a third state based on a second event; and based on the first value and an occurrence of the first event, transition from the first state to the second state; based on the second value, outputting a condition complete signal; a second circuit configurable to: responsive to the condition complete signal, determining a third event to monitor, the third event different than the second event; and transmit a response to the first circuit based on an occurrence of the third event; and the first circuit configurable to one of (a) transition from the second state to the third state based on reception of the response or (b) transition from the second state to the third state based on (i) a detection of the second event and (ii) reception of the response. Other examples are described.

### BRIEF DESCRIPTION OF THE DRAWINGS

FIGS. 1A and 1B include a device described in conjunction with examples described herein.

FIG. 2 is a block diagram to implement the repair circuitry of FIGS. 1A and 1B.

FIG. 3 illustrates an example state diagram of operation of the repair circuitry of FIG. 2.

FIG. 4A illustrates an example state diagram of operation of the repair circuitry of FIG. 2 in conjunction with state control circuitry in the device of FIGS. 1A and 1B.

FIG. 4B illustrates example states that may implement a state of the state diagram of FIG. 4A.

FIGS. 5A-5C includes a flowchart representative of a method, instructions, and/or operations that may be executed to implement the computing device of FIGS. 3 and 5.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

A device, such as an electrical device, a system-on-chip (SoC), a semiconductor device, an integrated circuit, etc. can combine multiple components of an electrical system. Such a device may include a state machine (e.g., hardware state machines, software state machines, and/or any other type of state machine) that control various operations such as power management, communication, and/or data processing of the device. For example, a state machine may be structured to change the states of the device between active, power down, standby, power up, shutdown, etc. A state machine maintains a particular state until a condition is true (e.g., when the condition/event occurs). Each state drives control to perform particular tasks and waits for feedback from previous tasks completed before transitioning to a subsequent state. In some examples, a state machine keeps a device in a first state for a threshold amount of time. After the threshold amount of time occurs, the state machine may transition from the first state to a second state. The condition may additionally or alternatively correspond to triggering of a digital signal (e.g., based on an edge of the digital signal), an analog signal satisfying a threshold amount (e.g., a voltage reaching a minimum voltage level), etc. Additionally or alternatively, the state machines may control power states, transitions of memories, transitions of clocks, bias control of circuits, monitoring circuits, etc.

Although state machines are used for critical power-up and state transition sequences, after a state machine is structured and/or programmed (e.g., with a list of states and corresponding conditions to transition to other states), the structure and/or implementation of the state machine may be fixed and cannot be corrected later on (e.g., after the device is implemented in silicon). For example, if a system designer, programmer, etc. structures and/or programs a state machine, after the device is produced onto silicon, there may be no way to change the state machine. For example, a hardware-based state machine, after produced onto silicon, cannot be restructured to adjust how the state machine operates. Thus, any mistake or miscalculation in the settings of the state machine cannot be mitigated, as further described below. Accordingly, to properly program/structure a state machine, a programmer, system designer, etc. may have to make particular assumptions regarding states or what triggers transitions between states. Additionally, the sequence of events for state transitions and the corresponding conditions for the state transitions are difficult to determine prior to implementation into silicon. For example, variations with respect to process corners, temperature, combinations of signal interaction, etc. may be difficult or impossible to verify pre-silicon. However, if the particular assumptions are wrong, if the programmer, system designer, etc. makes a mistake, or if it was difficult or impossible to verify process corners, temperatures, and/or combination of signal interactions, the device can result in state transition errors (e.g., never being able to adjust states or adjusting states before/after appropriate) that can render the device inoperable.

Examples disclosed herein provide a state machine repair or escape circuitry that can be programmed after a device has been implemented in silicon to adjust one or more conditions monitored by a state machine. Accordingly, if a state machine is incorrectly programmed/structured to switch states based on a problematic condition, the state machine repair/escape circuitry can be programmed to adjust the problematic condition to a different or additional condition after the device has been produced in silicon. Thus, examples disclosed herein provide a fallback for faulty design or changed conditions in the field that saves significant time, cost, and waste associated with faulty state machines.

For example, instead of discarding a device implemented in silicon and returning back to a pattern generation process, a resynthesizing and re-fabrication process, a fab out/tape out process, etc., which requires significant time and cost, a programmer, system designer, etc. can test the device, identify any problematic conditions for a state machine and adjust the conditions to repair the state machine. For example, if a programmer, system designer, etc. determines that a state machine has been programmed to transition from a first state to a second state when a particular node voltage reaches a threshold voltage but the transition occurs while a particular current is too low, thereby causing an issue, the programmer, system designer, etc. can program the state machine repair circuitry to change the condition from the first state to the second state to transition when both the node voltage is above the threshold voltage and the particular current is above a threshold current, thereby repairing the faulty condition without rerunning to the photomask generation process, the resynthesizing and re-fabrication process, the fab out/tape out process, etc. It can be beneficial to have the state machine repair circuitry on-chip to adjust the conditions of state transitions to improve the timing of state transitions, rather than a costly redesign of the device. While examples described herein are especially useful for modifying the conditions of hardware state machines, examples disclosed herein may also be configurable to modify the conditions of software state machines and state machines that are implemented in both hardware and software.

Although examples disclosed herein are described in conjunction with a power control state machine, examples disclosed herein can be extended to any type of hardware and/or software state machine (e.g., a state machine to control memory management, clock management, reset sequences, etc.). Additionally, the disclosed state machine repair circuitry makes use of existing components of a device and only minimally increases area and/or cost. Additionally, examples disclosed herein are platform architecture and/or process technology agnostic and can be implemented in different product lines, such as mixed signal processors (MSP), radar systems, algorithmic state machines (ASM), etc. While this disclosure describes the modification of state machine transitions for systems-on-chip, these techniques may be implemented for any other type of electrical device, such as semiconductor devices, integrated circuits, processing circuits, and/or analog devices.

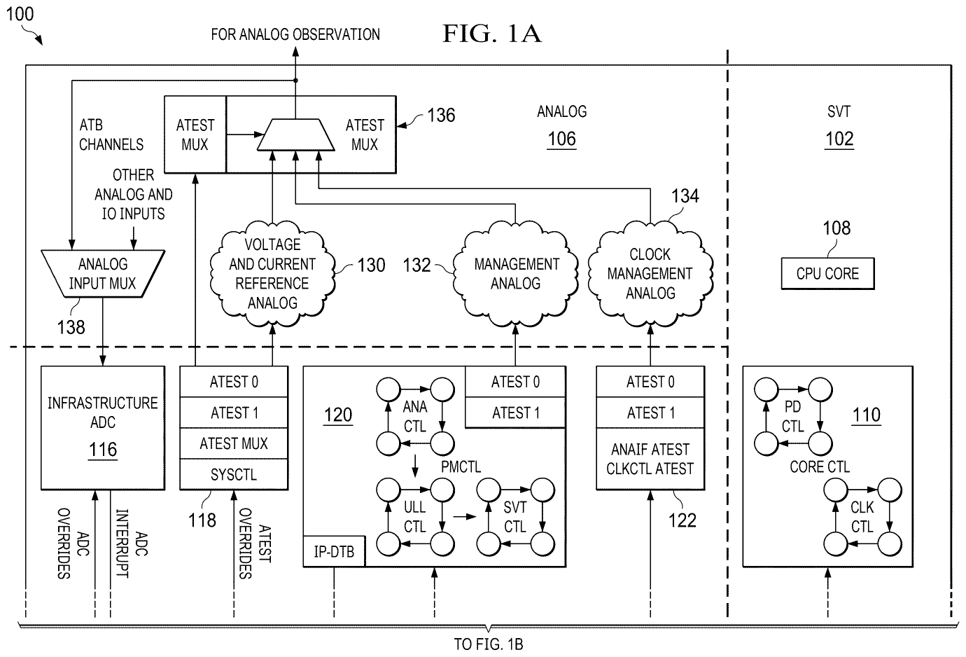

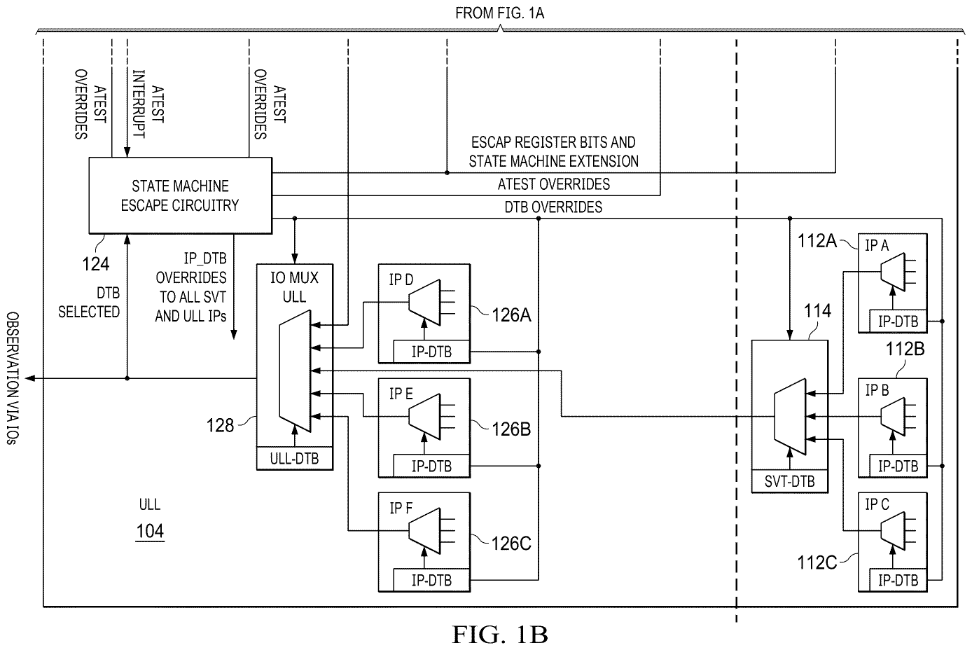

FIGS. 1A and 1B illustrate a schematic diagram of an example device 100. The device 100 may be a semiconductor device, an SoC, and integrated circuit, or any other electrical device or system. Device 100 may be implemented in a variety of systems, such as a data center, a server, an electronic device (e.g., phone, computer, television, etc.), an automobile or other vehicle, an industrial system, a robot, or a medical device, as just a few examples. The device 100 includes an example standard voltage threshold (SVT) portion 102, an example ultra-low leakage (ULL) portion 104, and an example analog portion 106. The SVT portion 102 includes an example core 108 (e.g., a central processing unit (CPU core), an example state machine 110, and example multiplexers (MUXs) 112a, 112b, 112c, 114. The ULL portion 104 includes an example analog-to-digital converter (ADC) 116, example digital-based analog device controllers 118, 122, an example state machine 120, example state machine escape circuitry 124 (also referred to as state machine repair circuitry), and MUXs 126a, 126b, 126c, 128. The analog portion 106 includes an example voltage and/or current reference system 130, an example analog management system 132, an example analog clock management system 134, and example MUXs 136, 138.

The SVT portion 102 of FIGS. 1A and 1B includes one or more of processing circuitry (e.g., the core 108, central processing unit(s) (CPU(s)), graphical processing unit(s) (GPU(s)), etc.), memory circuitry, high performance peripheral connections, digital radio circuitry, etc. that are implemented with SVT transistors that are high speed but have leakage current higher than ULL transistors. While the device 100 is programmed for a low-power mode, such as a standby mode, a deep low-power mode, a hibernation mode, etc., the SVT domain 102 may be powered off to conserve energy. A user, programmer, system designer, manufacturer, device, etc. can, during testing of the device 100, determine a state machine error corresponding to one or more faulty conditions for one or more states tracked by one or more of the state machines 110, 120. To overcome the error, the user, programmer, system designer, manufacturer, device, etc. can use the core 108 to execute a command to store a value in a register of the state machine escape circuitry 124 to adjust the faulty condition (e.g., by adding one or more additional conditions to the programmed condition for transitioning to a state, or replacing the programmed condition with a different condition for transitioning to a state).

In the example of FIGS. 1A and 1B, the SVT domain 102 includes the state machine 110. The state machine 110 is a device that transitions between different states based on an occurrence of one or more conditions (e.g., when a signal is asserted due to a duration of time, an edge of a signal, a signal exceeding a threshold, etc.). The state machine 110 may be implemented in hardware and/or software. In some examples, the state machine 110 can be implemented by a processor, a lookup table, state control circuitry, management circuitry, etc. The state machine 110 is programmed to transition between one or more states based on one or more conditions selected by a programmer, system designer, etc. before the device 100 is implemented into silicon. As further described below, after implemented in silicon, the state machine 110 can access values stored in registers of the state machine escape circuitry 124 to determine whether to follow the pre-defined state transition protocol or whether to wait for the state machine escape circuitry 124 to perform an alternative state transition protocol. When the state machine 110 determines that a value in a register for a particular state corresponds to an alternative condition, the state machine 110 outputs an “arm” signal to the state machine escape circuitry 124 when the state machine 110 is in the particular state. The “arm” signal triggers the state machine escape circuitry 124 to monitor the alternative condition and indicate, to the state machine 110, when the alternative condition occurred so that the state machine 110 can transition to a new state.

The MUXs 112a, 112b, 112c of FIGS. 1A and 1B are circuits that output a signal obtained via one of the input terminals based on a signal applied to the select terminal. The MUXs 112a, 112b, 112c include multiple input terminals, a select terminal, and an output terminal. The input terminals of the MUX 112a are coupled to various nodes of a first SVT circuit to be able to obtain digital signals at different nodes of the first SVT circuit. The input terminals of the MUX 112b are coupled to various nodes of a second SVT circuit to be able to obtain digital signals at different nodes of the second SVT circuit. The input terminals of the MUX 112c are coupled to various nodes of a third SVT circuit to be able to obtain digital signals at different nodes of the third SVT circuit. The number of input terminals for each MUX 112a, 112b, 112c and/or the number of MUXs 112a, 112b, 112c may be any number, based on the number of SVT circuits and/or the number of points of reference that a designer may wish to monitor. The select terminals of the MUXs 112a, 112b, 112c are coupled to the state machine escape circuitry 124. In this manner, the state machine escape circuitry 124 can output one or more signals to the select terminals to cause a particular digital signal to be obtained by the state machine escape circuitry to determine when a particular condition occurs. The output terminals of the MUXs 112a, 112b, 112c are coupled to the input terminals of the MUX 114.

The MUX 114 of FIGS. 1A and 1B is a circuit that outputs a signal obtained via one of the input terminals based on a signal applied to the select terminal. The MUX 114 includes multiple input terminals, a select terminal, and an output terminal. The input terminals of the MUX 114 are coupled to the output terminals of the MUXs 112a, 112b, 112c. The number of input terminals for the MUX 114 corresponds to the number of MUXs 112, 112b, 112c. The select terminal of the MUX 114 is coupled to the state machine escape circuitry 124. In this manner, the state machine escape circuitry 124 can output a signal to the select terminal to cause a particular digital signal to be obtained by the state machine escape circuitry to determine when a particular condition occurs. The output terminal of the MUX 114 is coupled to an input terminal of the MUX 128.

The ULL domain 104 of FIGS. 1A and 1B includes components utilizing ULL transistors. The ULL transistors are more efficient and consume less power than the SVT transistors but have lower performance than the SVT transistors. For example, the ADC 116, the controllers 118, 122, the state machine 120, the state machine escape circuitry 124, and/or the MUXs 126a, 126b, 126c, 128 may utilize lower power consumption and low-performance components that may implement one of more ULL transistors. Because the ULL domain 104 corresponds to lower power consumption, the ULL portion 104 is designed to be always on (e.g., does not enter sleep or low power mode).

The ADC 116 of FIGS. 1A and 1B converts an input analog signal to an output discrete digital representation. For example, the ADC can sample the analog signal at various points in time and generate a digital signal that represents the analog signal. The input of the ADC 116 is coupled to the output of the MUX 138. Thus, the ADC 116 converts the analog signal from the MUX 138 into a digital signal and provides the digital signal to the state machine escape circuitry 124. In this manner, the state machine escape circuitry 124 can monitor when a particular analog signal has reached a threshold based on the digital output of the ADC 116. In some examples, the state machine escape circuitry 124 can output a signal to cause the enable or disable of the ADC 116. Accordingly, when the state machine escape circuitry 124 does not need to monitor an analog signal, the ADC 116 can be powered down or put in low power mode or turned off to conserve resources.

The analog device controller 118 of FIGS. 1A and 1B is a digital controller that can control the analog voltage and current reference system 130. For example, the analog device controller 118 can instruct the analog voltage and current reference system 130 to perform one or more tests and output one or more voltages and/or currents. One or more voltage and/or currents can be processed by the state machine escape circuitry 124 when monitoring a condition. The analog device controller 118 can also output a control signal to a select terminal of the MUX 136 to cause the voltage and/or current that the state machine escape circuitry 124 is monitoring to be transmitted to the state machine escape circuitry 124 via the MUXs 136, 138 and the ADC 116.

The state machine 120 of FIGS. 1A and 1B is a device that transitions between different states based on an occurrence of one or more conditions (e.g., when a signal is asserted due to a duration of time, an edge of a signal, a signal exceeding a threshold, etc.). The state machine 120 may be implemented in hardware and/or software. In some examples, the state machine 120 can be implemented by a processor, a lookup table, state control circuitry, management circuitry, etc. The state machine 120 is programmed to cause the analog management system 132 to transition between one or more states based on one or more conditions selected by a designer before the device 100 is implemented into silicon. As further described below, after implemented in silicon, the state machine 120 can access values stored in registers of the state machine escape circuitry 124 to determine whether to follow the pre-defined state transition protocol or whether to wait for the state machine escape circuitry 124 to perform an alternative state transition protocol. When the state machine 120 determines that a value in a register for a particular state corresponds to an alternative condition, the state machine 120 outputs an “arm” signal to the state machine escape circuitry 124 when the state machine 120 is in the particular state. The “arm” signal triggers the state machine escape circuitry 124 to monitor the alternative condition and indicate, to the state machine 120, when the alternative condition occurred so that the state machine 120 can cause the management system 132 to transition to a new state.

The analog device controller 122 of FIGS. 1A and 1B is a digital controller that can control the analog clock management system 134. For example, the analog device controller 122 can instruct the analog clock management system 134 to perform one or more tests and output one or more clock signals. The one or more clock signals can be processed by the state machine escape circuitry 124 when monitoring a condition. The analog device controller 122 can also output a control signal to a select terminal of the MUX 136 to cause the clock signals that the state machine escape circuitry 124 is monitoring to be transmitted to the state machine escape circuitry 124 via the MUXs 136, 138 and the ADC 116.

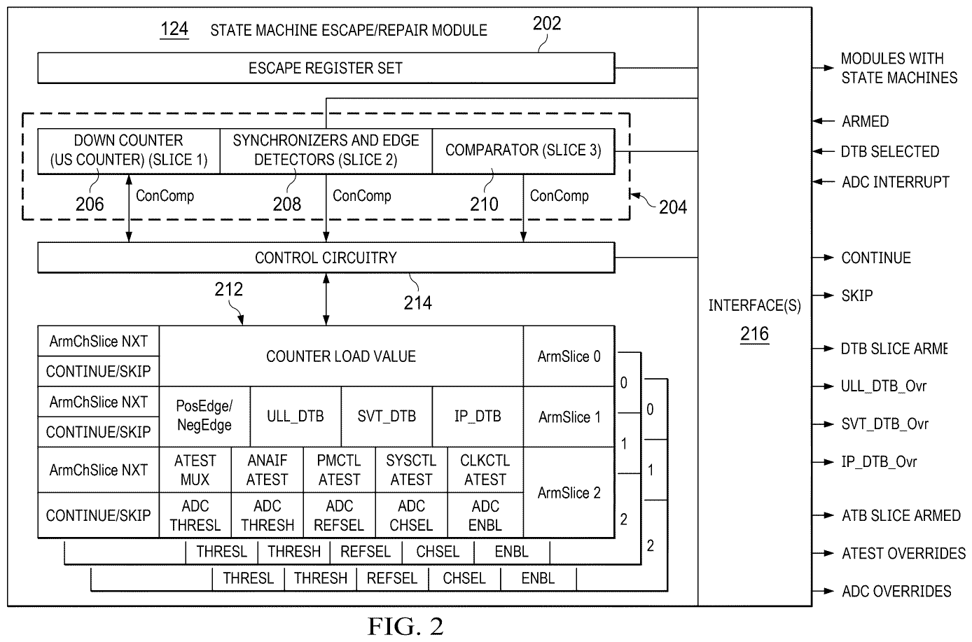

The state machine escape circuitry 124 of FIGS. 1A and 1B is circuitry that can be programmed to adjust one or more conditions for state transitions programmed and/or structured into the state machines 120, 110. The state machine escape circuitry 124 may be programmable via an external interface of device 100. For example, the state machine escape circuitry 124 can include a first plurality or registers with values corresponding to each state of the state machines 110, 120. Initially, the values may be set to a first value (e.g., zero), which signifies no override of the conditions for state transitions of the state machines 110, 120. However, a programmer/device can adjust the condition(s) for a transition from a first state to a second state for one or more of the state machines 110, 120 by changing the initial value of a register that corresponds to the first state to a second value (e.g., one). Additionally, the state machine escape circuitry 124 includes a second plurality of registers that can store information related to the adjusted condition that the programmer has programmed. For example, the programmer can store one or more values in the second plurality of registers indicative of one or more conditions corresponding to waiting for a threshold amount of time, waiting until an edge (e.g., rising and/or falling) of a digital signal has been identified, and/or waiting until an analog signal has reached a threshold. The state machine escape circuitry 124 further includes counter circuitry to add delay, edge detector circuitry to detect an edge of a digital signal, and/or a comparator to determine when an analog signal reaches a threshold. Adding or reducing delay, detecting an edge, and thresholding an analog signal may be beneficial to cause a state machine to transition states at a more desirable/accurate time (e.g., when the conditions are appropriate for a transition), rather than too late or too early. Thus, the state machine escape circuitry 124 prevents the state machine 110, 120 from adjusting from a first state to a second state until an alternate condition occurs (a condition different from how the state machine 110, 120 was initially designed). After the alternate condition occurs, the state machine escape circuitry 124 indicates the state machine 110, 120 to transition from the first state to the second state. Additionally, the state machine escape circuitry 124 can output control signals to the MUXs 112a, 112b, 112c, 114, 126a, 126b, 126c, 128, 136, 138 and/or the controllers 118, 122 to obtain a signal for condition monitoring. The state machine escape circuitry 124 is further described below in conjunction with FIG. 2. Although FIGS. 1A and 1B illustrate a single state machine escape circuitry, the device 100 may include N number of state machine escape circuitries for the N state machines on the device 100. Thus, each state machine escape circuitry may correspond to a single state machine.

The MUXs 126a, 126b, 126c of FIGS. 1A and 1B are circuits that output a signal obtained via one of the input terminals based on a signal applied to the select terminal. The MUXs 126a, 126b, 126c include multiple input terminals, a select terminal, and an output terminal. The input terminals of the MUX 112a are coupled to various nodes of a first Ultra Low Leakage (ULL) circuit to be able to obtain digital signals at different nodes of the first ULL circuit. The input terminals of the MUX 112b are coupled to various nodes of a second ULL circuit to be able to obtain digital signals at different nodes of the second ULL circuit. The input terminals of the MUX 112c are coupled to various nodes of a third ULL circuit to be able to obtain digital signals at different nodes of the third ULL circuit. The number of input terminals for each MUX 126a, 126b, 126c and/or the number of MUXs 126a, 126b, 126c may be any number, based on the number of ULL circuits and/or the number of points of reference that a designer may wish to monitor. The select terminals of the MUXs 126a, 126b, 126c are coupled to the state machine escape circuitry 124. In this manner, the state machine escape circuitry 124 can output one or more signals to the select terminals to cause a particular digital signal to be obtained by the state machine escape circuitry to determine when a particular condition occurs. The output terminals of the MUXs 126a, 126b, 126c are coupled to the input terminals of the MUX 128.

The MUX 128 of FIGS. 1A and 1B is a circuit that outputs a signal obtained via one of the input terminals based on a signal applied to the select terminal. The MUX 128 includes multiple input terminals, a select terminal, and an output terminal. The input terminals of the MUX 128 include first input terminals that are coupled to the output terminals of the MUXs 126a, 126b, 126c and a second input terminal that is coupled to the output terminal of the MUX 114. The number of input terminals for the MUX 128 corresponds to the number of MUXs 112, 112b, 112c. The select terminal of the MUX 128 is coupled to the state machine escape circuitry 124. In this manner, the state machine escape circuitry 124 can output a signal to the select terminal to cause a particular digital signal to be obtained by the state machine escape circuitry to determine when a particular condition occurs. The output terminal of the MUX 128 is coupled to the state machine escape circuitry 124 and can be provided to a pin (e.g., input/output terminal or pin) of the device 100 so that a user, programmer, manufacturer, and/or device (e.g., an external programmer device) can test or observe signals on the device 100.

The analog current and voltage reference system 130 of FIGS. 1A and 1B includes analog circuitry to generate one or more voltages and currents that may be applied to various components of the device 100. In some examples, the controller 118 instructs the analog current and voltage reference system 130 to generate particular voltage(s) and/or current(s). The voltages and/or currents generated by the analog current and voltage reference system 130 can be output to the MUX 136 for monitoring and/or observation, as further described below.

The analog management system 132 of FIGS. 1A and 1B includes analog circuitry to manage the power (or other functionality) of the device 100 based on instructions from the state machine 120. For example, the state machine 120 may control the management system 132 to perform tasks to enter and/or remain in a standby state, a power up state, an active state, a power down state, a shutdown state, etc. Various signals within, output by, and/or received by the management system 132 can be output to the MUX 136 for monitoring and/or observation, as further described below.

The clock management system 134 of FIGS. 1A and 1B includes analog circuitry to generate one or more clocks based on instructions from the controller 122. For example, the controller 122 may control the clock management system 134 to generate one or more clock signals of various different frequencies. Various signals within, output by, and/or received by the clock management system 134 can be output to the MUX 136 for monitoring and/or observation, as further described below.

The MUX 136 of FIGS. 1A and 1B is a circuit that outputs a signal obtained via one of the input terminals based on a signal applied to the select terminal. The MUX 136 includes multiple input terminals, a select terminal, and an output terminal. The first input terminal of the MUX 136 is coupled to the analog voltage and current reference system 130, the second input terminal of the MUX 136 is coupled to the analog management system 132, and the third input terminal of the MUX 136 is coupled to the clock management system 134. The select terminal of the MUX 136 is coupled to the controller 118. In this manner, the state machine escape circuitry 124 can output a signal via the controller 118 to the select terminal to cause a particular analog signal to be obtained by the state machine escape circuitry to determine when a particular condition occurs. The output terminal of the MUX 136 is coupled to the state machine escape circuitry 124 (e.g., via the MUX 138) and can be provided to a pin (e.g., input/output terminal or pin) of the device 100 so that a user, programmer, manufacturer, and/or device can test or observe signals on the device 100.

The MUX 138 of FIGS. 1A and 1B is a circuit that outputs a signal obtained via one of the input terminals based on a signal applied to the select terminal. The MUX 138 includes a first input terminal coupled to the output of the MUX 136 and second input terminal(s) that may be coupled to other analog and/or IO inputs of the device 100. The MUX 138 further includes a select terminal (not shown) that is coupled to the state machine escape circuitry 124. In this manner, the state machine escape circuitry 124 can control which analog signal is obtained by controlling the select terminal of the MUX 138. The output terminal of the MUX 138 is coupled to the ADC 116.

FIG. 2 is a block diagram of an example implementation of the state machine escape circuitry 124 of FIGS. 1A and 1B. The state machine escape circuitry 124 of FIGS. 1A and 1B includes an example escape register set 202, example condition monitoring circuitry 204, which includes example counter circuitry 206, example edge detection circuitry 208, and an example comparator 210 (also referred to as comparator circuitry), example state machine escape information registers 212, example control circuitry 214, and example interface circuitry 216. The state machine escape circuitry 124 is described as a single channel used in conjunction with the state machine 120 of FIGS. 1A and 1B. However, FIG. 2 may be used to describe state machine escape circuitry for a different channel (e.g., in conjunction with the state machine 110 or another state machine of the device 100)

The escape register set 202 of FIG. 2 includes registers for each state of a state machine. Each register stores a value (e.g., zero or one) to indicate whether the condition for the corresponding state is to be adjusted by the state machine escape circuitry 124. Initially, the values are all set to a first value (e.g., zero) to indicate that no adjustments to the corresponding state machine are needed. However, a user/device can use the core 108 of FIGS. 1A and 1B to execute a command to change the value of any one of the registers to a second value (e.g., one) when adjustment of the condition for the corresponding state is desired (e.g., for proper state transitions). As described above, the state machines 120 can access (e.g., via the interface circuitry 216) the values stored in the escape register set 202 to determine if a particular state has been selected to be overridden by the state machine escape circuitry 124. For each register within the escape register set 202 that is set to a value of one, the programmer also selects a particular slice and a particular channel, and stores information within ArmSlice X of state machine escape information registers 212 as the start of the repair condition(s).

The condition monitoring circuitry 204 of FIG. 2 is structured to monitor conditions for state transitions and output a condition complete (“ConComp”) signal (also referred to as an enable signal or event indication signal) to the control circuitry 214 when a condition is true. For example, the condition monitoring circuitry 204 includes the counter circuitry 206 to trigger the condition complete signal after a threshold amount of time has occurred, thereby adding delay. A value indicating the threshold amount of time is stored in one of the registers 212 by a user, programmer, device, and/or manufacturer, as further described below. The condition monitoring circuitry 204 further includes edge detection circuitry 208 to output the condition complete signal after detecting a rising and/or falling edge of a digital signal. The details of which signal to monitor and/or what control signals to apply to the MUXs 112a-112c, 114, 126a-c, 128 to obtain the corresponding digital signal and whether to trigger a signal based on a rising or falling edge of the corresponding signal are stored in the registers 212, as further described below. The condition monitoring circuitry 204 further includes the comparator 210 to output a condition complete signal after detecting that an analog signal has reached a threshold. The details of which signal to monitor and/or what control signals to apply to the MUXs 136, 138 and/or the controllers 118, 122 to obtain the corresponding analog signal and the threshold(s) are stored in the registers 212, as further described below.

The state machine escape information registers 212 of FIG. 2 store information provided by the command from the user, programmer, device, and/or manufacturer to adjust a monitored condition for a state of one or more of the state machines 120. The state machine escape information registers 212 includes a first set of registers for a first state of the state machine 120, a second set of registers for a second state of the state machine 120, etc. In this manner, the programmer can provide information related to alternative condition(s) to monitor for any one or more states of the state machine 120. The first set of the registers of the state machine escape information registers 212 includes the slices or groups of registers that correspond to the three different conditions that can be programmed. The first slice of registers corresponds to a first condition corresponding to added delay. The second slice of registers corresponds to a second condition corresponding to a digital signal. The third slice of registers corresponds to a third condition corresponding to an analog signal.

Each delay slice of the first set of the registers 212 of FIG. 2 includes an “ArmChSlice Nxt” register that includes a value that is used to arm or disarm a different channel and/or slice after the current armed slice ends and generates a condition complete signal. For example, if a programmer wishes to add a new condition for a state based on a rising edge of a digital signal after 10 milliseconds of delay, the programmer can program the details related to the 10 milliseconds of delay and include a value in the “ArmChSlice Nxt” register that indicates that the second digital monitoring slice should be activated/armed after the 10 milliseconds delay is complete. Accordingly, the “ArmChSlice Next” register allows a programmer to program multiple part conditions (e.g., including two or more of delay, digital edge detection, and/or analog threshold detection), if desired. Each delay slice of the first set of registers 212 further includes a “Continue/Skip” register that includes a value that is used to indicate what the state machine 120 should do in response to receiving an indication that one or more adjusted conditions has/have occurred. For example, if the value in the “Continue/Skip” register includes a first value corresponding to Continue, the state machine escape circuitry 124 transmits a continue signal after the adjusted condition(s) has/have occurred to the state machine 120 to indicate that the state machine 120 should continue to check for the original condition it was programmed to check for before switching to a new state. If the value in the “Continue/Skip” register includes a second value corresponding to Skip, the state machine escape circuitry 124 transmits a continue signal after the adjusted condition(s) has/have occurred to the state machine 120 to indicate that the state machine 120 should skip to a new state without checking for the original condition it was programmed to check for. Each delay slice of the first set of registers 212 further includes a “ArmSlice X” register that stores a value corresponding to an initial condition to monitoring (e.g., which first condition to monitor for the corresponding state). For example, if there is a first value (e.g., zero) stored in the “ArmSlice 0” and the “Arm Slice 1” register and a second value (e.g., one) stored in “ArmSlice 2” register, then analog monitoring will be the first condition/slice enabled for the corresponding state indication of a subsequent slice to enable is based on the values in the “ArmChSlice Next” register, as further described above.

The first (e.g., delay) slice of the first set of the registers 212 of FIG. 2 includes a “counter load value” register that includes a value that corresponds to an amount of delay that the programmer desires to add for a state of the state machine 120. For example, the programmer can use the core 108 to store a threshold amount of time to wait before triggering an output signal or arming a next slice (e.g., a subsequent condition to monitor). As further described below, when the programmer programs the delay value into the counter load value register and the corresponding state occurs, the control circuitry 214 loads the counter 206 with a value that corresponds to the amount of delay defined by the programmer to wait for the delay to occur.

The second (e.g., digital) slice of the first set of the registers 212 of FIG. 2 includes a “PosEdge/NegEdge/Level” register that stores one or more values corresponding to whether a monitor condition corresponds to a positive edge of a digital signal, a negative edge of a digital signal, and/or the digital signal reaching a selected level (e.g., zero and/or one). The second slice of the first set of the registers 212 further includes a “ULL_DTB” register stores value(s) that identifies the signal to apply to the select terminal of the MUX 128 to obtain the digital signal of interest (e.g., the digital signal to monitor for the condition). The second slice of the first set of the registers 212 further includes a “SVT_DTB” register that stores value(s) identifying the signal to apply to the select terminal of the MUX 114 to obtain the digital signal of interest (e.g., the digital signal to monitor for the condition). The second slice of the first set of the registers 212 further includes a “IP_DTB” register that identifies the signal to apply to the select terminal of the MUXs 112a-c, 126a-c to obtain the digital signal of interest (e.g., the digital signal to monitor for the condition).

The third (e.g., analog) slice of the first set of the registers 212 of FIG. 2 includes a “ATEST MUX” register that stores value(s) that identifies the signal to apply to the select terminal of the MUX 126 to obtain the analog signal of interest (e.g., the analog signal to monitor for the condition). The third slice of the first set of the registers 212 further includes a “ANAIF ATEST” register, a “PMCTL ATEST” register, a “SYSCTL ATEST,” and a “CLKCTL ATEST” register storing values that identify analog test controls for the analog systems 130, 132, 314 to obtain an analog signal of interest (e.g., the analog signal to monitor for the condition). The third slice of the first set of the registers 212 further includes an “ADC threshold high” register that stores a value corresponding to a maximum threshold the analog signal reaches to trigger a completion of the condition. The third slice of the first set of the registers 212 further includes an “ADC threshold low” register that stores a value corresponding to a minimum threshold the analog signal reaches to trigger a completion of the condition. The third slice of the first set of the registers 212 further includes an “ADC REFSEL” register that stores a value corresponding to the internal ADC reference that is selected based on the analog input signal being converted (e.g., VDDS or internal VREF of 1.4 or 2.5 Volts). The third slice of the first set of the registers 212 further includes an “ADC CHSEL” register that stores a value to configure the correct ATEST input channel to be converted (e.g., which controller 118, 122 to send a control signal to). The third slice of the first set of the registers 212 further includes an “ADC ENBL” register that stores a value corresponding to enabling the ADC 116 to convert the analog signal to a digital signal.

The second, third, etc. sets of the registers 212 of FIG. 2 also include registers structured in a similar manner as the first set of the registers 212 but storing values corresponding to different states of the state machine 120 that may need to be repaired/fixed via the state machine escape circuitry 124. In this manner, the control circuitry 214 can select a set of the registers corresponding to the all states of a state machine 120 which may need to be repaired.

The control circuitry 214 of FIG. 2 controls, based on obtaining an “armed” signal from the state machine 120) the condition monitoring circuitry 204 to monitor one or more conditions and trigger one or more condition complete signals based on the information stored in the registers 212. As described above, the state machine 120 accesses the values in the escape register set 202 to determine whether the condition(s) for a particular state have been adjusted by a programmer. For example, if the programmer/device adjusts the conditions for an active state, the programmer/device stores a value in a register of the escape register set 202 to indicate to the state machine 120 that the active state condition(s) have been altered. Accordingly, when the state machine 120 enters the active state, the state machine 120 outputs the “armed” signal to the control circuitry 214 (via the interface circuitry 216) to indicate that the sate machine 120 is in the active state.

After the “armed” signal corresponding to the state of state-machine 100 which has been programmed to be fixed within the escape register set 202 has been obtained, the control circuitry 214 of FIG. 2 determines which state the state machine 120 is in by the signal position of the set bit within the ‘Armed’ bus. In the above example, the control circuitry 214 determines that the state machine 120 is in an active state when the armed bit set position on the interface 216 corresponds to the active state register bit position within the escape register set 202 and identifies the slice of the registers 212 that has been programmed to repair the active state of the state machine 120 via the programming between the active state register bit within the escape register set 202 and a selected ArmSlice N within a register of the registers 212 (not shown in FIG. 2). After the control circuitry 214 identifies the slice of the registers 212, the control circuitry 214 determines which data to process based on which of the “ArmSlice N” registers have been selected. The control circuitry 214 processes the determined information to instruct the condition monitoring circuitry 204 to output a condition complete signal after a monitored condition has occurred based on the determined information. For example, the control circuitry 214 can, based on the values in the registers 212, (a) set the counter circuitry 206 to the counter load value to output a condition complete signal after a desired delay occurred, (b) instruct the edge/level detector circuitry 208 to output a condition complete signal based on detection of a positive and/or negative edge and/or level of an incoming digital signal, or (c) instruct the comparator 210 to output a condition complete signal based on an analog signal satisfying one or more thresholds. When digital signal monitoring and/or analog signal monitoring is/are enabled, the control circuitry 214 determines the appropriate signal to send to the select terminal of the controllers 118, 122 and/or MUXs 112a-c, 114, 126a-c, 128, 136, 138 to obtain the target digital and/or analog signal to monitor. After the condition complete signal is obtained, the control circuitry 214 checks the “ArmChSlice Nxt” register to see if a subsequent condition is to be monitored of if the condition monitoring is complete. After all enabled conditions are complete, the control circuitry 214 determines whether to output a response (e.g., a continue signal or a skip signal) to the state machine 120 based on the value stored in the corresponding “continue/skip” register of the registers 212. In some examples, if multiple conditions are armed for the same state, the last “continue/skip” register for an armed condition is used to determine whether to continue or skip the preprogrammed condition monitored by the state machine 120.

The interface circuitry 216 of FIG. 2 may include one or more interface circuits to obtain and/or transmit signals throughout the device 100. For example, the interface circuitry 216 can obtain “armed” signals from state machines of the device 100, “DTB selected” signals from the output of the MUX 128, and “ADC interrupt” signals from the ADC 116. Additionally, the interface circuitry 216 can transmit values from the escape register set, a “continue” signal, and/or a “skip” signal to the state machine 120. Additionally, the interface circuitry 216 can send control signals (e.g., “ULL_DTB_Ovr,” “SVT_DTB_Ovr,” “IP_DTB_Ovr”) to the select terminals of the MUXs 112a-c, 114, 126a-c, 128. Additionally, the interface circuitry 216 can send control signals (e.g., “ATEST overrides,” “ADC overrides,” etc.) to the controllers 118, 122 and/or the ADC 116. Additionally, the interface circuitry 216 can send control signals (e.g., “DTB slice armed” and “ATB slice armed”) to other state machine escape circuitry 124 on the device 100, if implemented, to ensure that no two escape modules try to use the same digital test bus and analog test bus MUXs 112a-c, 114, 126a-c, 128 at the same time.

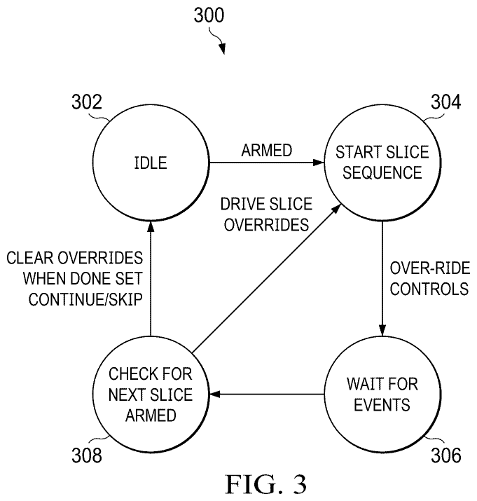

FIG. 3 is an example state diagram 300 illustrating an example operation of the state machine escape circuitry 124 of FIGS. 1 and/or 2. The example state diagram 300 of FIG. 3 includes example states 302, 304, 306, 308. The first state 302 is an idle state, the second state 304 is a start slice sequence state, the third state 306 is a wait for event/condition state, and the fourth state is a check for next slice armed state 308.

During the first state 302, the state machine escape circuitry 124 remains idle while the state machine 120 functions normally. If, during the first state 302, the state machine escape circuitry 124 receives an “armed” signal from the state machine 120, the state machine escape circuitry 124 transitions to the second state 304. In the second state 304, the state machine escape circuitry 124 determines which conditions to monitor based on the values in the registers 212. Additionally, during the second state 304, the state machine escape circuitry 124 sets up the condition monitoring circuitry 204 based on which condition is to be monitored and the setup information stored in the registers 212. Additionally, during the second state 304, the state machine escape circuitry 124 may output control signals to obtain a target signal to monitor. After the state machine escape circuitry 124 outputs the override controls to signify the start of condition monitoring, the state machine escape circuitry 124 transitions to the third state 306. During the third state, the state machine escape circuitry 124 waits until the monitored condition occurs (e.g., a threshold amount of delay occurring, detection of an edge/level of a digital signal, or detection of an analog signal satisfying a threshold). After the event occurs, the state machine escape circuitry 124 transitions to the fourth state 308. At the fourth state 308, the state machine escape circuitry 124 checks the “ArmChSlice Next” register of the register 212 to determine if a subsequent slice/condition is to be monitored. If a subsequent slice/condition is to be monitored, the state machine escape circuitry 124 transitions to the second state 304. If a subsequent slice/condition is not to be monitored, the state machine escape circuitry 124 transitions to the first state 302 by outputting a “continue” or “skip” signal based on the value stored in the “continue/skip” register of the registers 212.

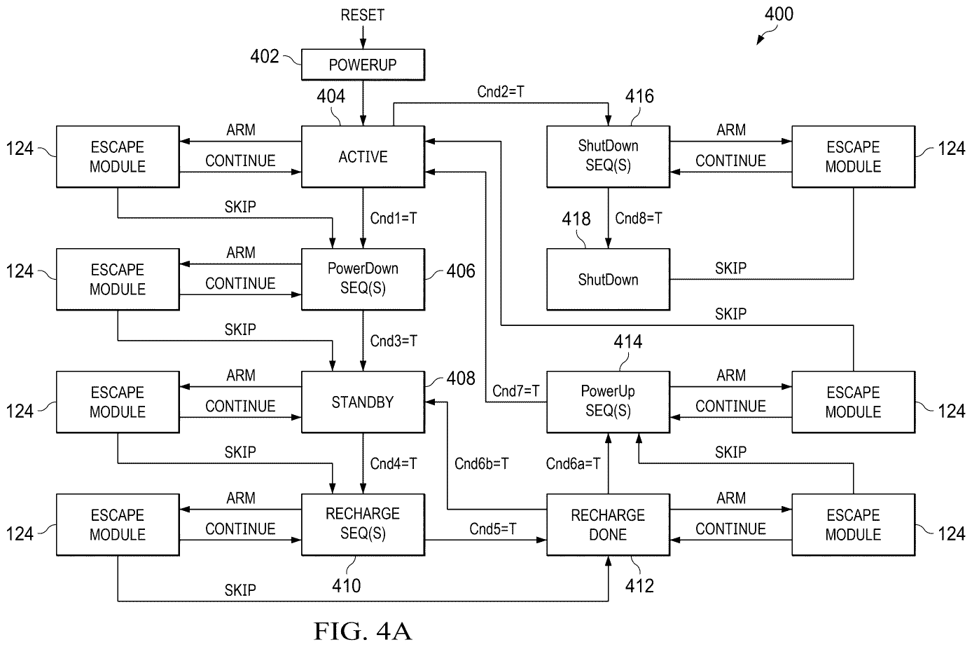

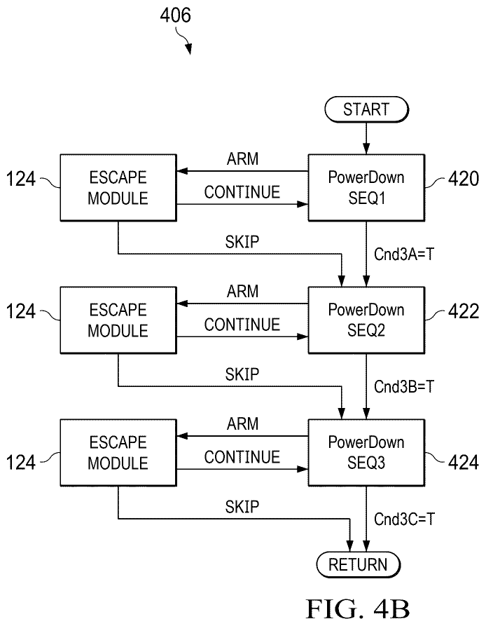

FIG. 4A is an example state diagram 300 illustrating an example operation of the state machine 120 in conjunction with the state machine escape circuitry 124 of FIGS. 1 and/or 2. The example state diagram 400 of FIG. 4A includes example states 402, 404, 406, 408, 410, 412, 414, 416, 418. Although FIG. 4A illustrates example states and transitions for the state machine 120, the number and/or order of the states and/or transitions can be different for different state machines. In some examples, any of the states 402, 404, 406, 408, 410, 414, 416, 418 may each include multiple states with multiple escape opportunities. For example, the power down state 406 of FIG. 4A may include multiple power down states, as further described below in conjunction with FIG. 4B.

The first state 402 is a power-up state that occurs after a reset of the device 100 of FIGS. 1A and 1B. After the power-up state is complete (e.g., after 10 microseconds of delay and a bias analog signal and a power supply reaching a threshold), the state machine 120 transitions to the active state 404. During the active state 404, the state machine 120 is structured to monitor for a first condition (Cnd1) (e.g., a positive edge of a standby digital signal) and a second condition (Cnd2) (e.g., a positive edge of a shutdown digital signal). Since there are two possible branches from state 402, there are two register bits within the escape register set 202 for possible repair action-one towards the power-down branch, and one towards the shut-down branch. The state machine 120 checks the value for the active state 404 in the escape register set 202 of the escape circuitry 124 for the power-down branch register and the shut-down branch registers. If the values for the power-down branch of the active state and shut-down branch registers are a first value (e.g., zero), the state machine 120 continues with normal operation towards the power down branch and shut-down branch. For example, If the second condition occurs (e.g., Cnd2=True), the state machine 120 transitions to the shutdown sequence state 416, as further described below. If the first condition occurs (e.g., Cnd1=True), the state machine 120 transitions to the power-down sequence state 406. However, if the value for the active state is a second value (e.g., one) for either branch, the state machine 120 outputs an armed signal to the state machine escape circuitry 124, corresponding to that branch. In this manner, the state machine escape circuitry 124 can monitor an additional or alternative condition than the first condition(s). After the state machine escape circuitry 124 determines that the additional or alternative has occurred, the state machine escape circuitry 124 can output a response (e.g., “continue” signal or a “skip” signal) to the state machine 120 based on user/programmer/manufacturer/device commands. The state machine 120 continues operation based on reception of the response. For example, if the state machine escape circuitry 124 outputs the “continue” signal to the power-down branch, the state machine 120 continues in the active state 404 until the first condition is true, and if it outputs a ‘continue’ signal to the shut-down branch, it waits for the second condition to be true. If the state machine escape circuitry 124 outputs the “skip” signal, the state machine 120 skips to the power-down sequence state 406 in the power-down branch, or the shutdown sequence state(s) 416 when the alternative condition(s) within the shut-down branch completes.

During the power-down sequence state 406, the state machine 120 is structured to monitor for third condition(s) (Cnd3) (e.g., a positive edge of a DCDCoff digital signal, a negative edge of a bandgap digital signal, and/or a positive edge of a standby_qual signal). However, the state machine 120 checks the value for the power-down sequence state 406 in the escape register set 202 of the escape circuitry 124. If the value for the power-down sequence state 406 is a first value (e.g., zero), the state machine 120 continues with normal operation. For example, if the third condition occurs (e.g., Cnd3=True), the state machine 120 transitions to the standby state 408, as further described below. However, if the value for the power-down sequence state 406 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the power-down sequence state 406 until the third condition is true. If the state machine escape circuitry 124 outputs the “skip” signal, the state machine 120 skips to the standby state 408. An example of different states that may make up the power-down sequence state 406 of FIG. 4A is further described below in conjunction with FIG. 4B.

During the standby state 408, the state machine 120 is structured to monitor for fourth condition(s) (Cnd4) (e.g., a positive edge of a wake event digital signal). However, the state machine 120 checks the value for the standby state 408 in the escape register set 202 of the escape circuitry 124. If the value for the standby state 408 is a first value (e.g., zero), the state machine 120 continues with normal operation. For example, if the fourth condition occurs (e.g., Cnd4=True), the state machine 120 transitions to the recharge sequence state 410, as further described below. However, if the value for the standby state 408 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the standby state 408 until the fourth condition is true. If the state machine escape circuitry 124 outputs the “skip” signal, the state machine 120 skips to the recharge sequence state 410.

During the recharge sequence state 410, the state machine 120 is structured to monitor for fifth condition(s) (Cnd5) (e.g., a positive edge of a bandgap signal, 8 microseconds of delay, a positive edge of a BOD signal, a positive edge of a BMON signal, and a negative edge of a CLKRQ signal). However, the state machine 120 checks the value for the recharge sequence state 410 in the escape register set 202 of the escape circuitry 124. If the value for the recharge sequence state 410 is a first value (e.g., zero), the state machine 120 continues with normal operation. For example, if the fifth condition occurs (e.g., Cnd5=True), the state machine 120 transitions to the recharge done state 412, as further described below. However, if the value for the recharge sequence state 410 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the recharge sequence state 410 until the fifth condition is true. If the state machine escape circuitry 124 outputs the “skip” signal, the state machine 120 skips to the recharge done state 412.

During the recharge done state 412, the state machine 120 is structured to monitor for sixth conditions (Cnd6a and Cnd6b) (e.g., a level of a wake up signal keeping high or keeping low). However, the state machine 120 checks the value for the recharge done state 412 in the escape register set 202 of the escape circuitry 124. If the value for the recharge done state 412 is a first value (e.g., zero), the state machine 120 continues with normal operation. For example, if the sixth_a condition occurs (e.g., Cnd6a=True), the state machine 120 transitions to the power-up sequence state 414, as further described below. If the sixth_b condition occurs (e.g., Cnd6b=True), the state machine 120 transitions to the standby sequence state 408. However, if the value for the recharge done state 412 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the recharge done state 412 until the sixth condition is true. If the state machine escape circuitry 124 outputs the “skip” signal, the state machine 120 skips to the power-up sequence state 414.

During the power-up sequence state 414, the state machine 120 is structured to monitor for a seventh condition (Cnd7) (e.g., a positive edge of a BOD signal, a positive edge of an SVT EN signal, a positive edge of a CLK GOOD signal). However, the state machine 120 checks the value for the power-up sequence state 414 in the escape register set 202 of the escape circuitry 124. If the value for the power-up sequence state 414 is a first value (e.g., zero), the state machine 120 continues with normal operation. For example, if the seventh condition occurs (e.g., Cnd7=True), the state machine 120 transitions to the active state 404, as further described above. However, if the value for the power-up sequence state 414 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the power-up sequence state 414 until the seventh condition is true. If the state machine escape circuitry 124 outputs the “skip” signal, the state machine 120 skips to the active state 404.

During the shutdown sequence state 416, the state machine 120 is structured to monitor for an eight condition (Cnd8) (e.g., a negative edge of the BOD EN signal and/or 2 microseconds of delay). However, the state machine 120 checks the value for the shutdown sequence state 416 in the escape register set 202 of the escape circuitry 124. If the value for the shutdown sequence state 416 is a first value (e.g., zero), the state machine 120 continues with normal operation. For example, if the eighth condition occurs (e.g., Cnd8=True), the state machine 120 transitions to the shutdown state 418, as further described above. However, if the value for the shutdown sequence state 416 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the shutdown sequence state 416 until the eight condition is true. If the state machine escape circuitry 124 outputs the “skip” signal, the state machine 120 skips to the shutdown state 418.

FIG. 4A is an example implementation of the states that may make up the power down state 406 of FIG. 4B. The power down state 406 of FIG. 4B includes example states 420, 422, 424. Although FIG. 4B illustrates example states and transitions for the state machine 120, the number and/or order of the states and/or transitions can be different for different state machines.

During the first power-down sequence state 420, the state machine 120 is structured to monitor for condition(s) (Cnd3A) (e.g., a positive edge of a DCDCoff digital signal). However, the state machine 120 checks the value for the power-down sequence state 420 in the escape register set 202 of the escape circuitry 124. If the value for the power-down sequence state 420 is a first value (e.g., zero), the state machine 120 continues with normal operation. For example, if the condition occurs (e.g., Cnd3A=True), the state machine 120 transitions to the second power-down sequence state 420, as further described below. However, if the value for the power-down sequence state 420 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the power-down sequence state 420 until the third condition is true. If the state machine escape circuitry 124 outputs the “skip” signal, the state machine 120 skips to the second power-down sequence state 422.

During the second power-down sequence state 422, the state machine 120 is structured to monitor for condition(s) (Cnd3B) (e.g., a negative edge of a bandgap digital signal). However, the state machine 120 checks the value for the power-down sequence state 422 in the escape register set 202 of the escape circuitry 124. If the value for the power-down sequence state 422 is a first value (e.g., zero), the state machine 120 continues with normal operation. For example, if the third condition occurs (e.g., Cnd3B=True), the state machine 120 transitions to the third power-down sequence state 424, as further described below. However, if the value for the power-down sequence state 422 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the power-down sequence state 422 until the third condition is true. If the state machine escape circuitry 124 outputs the “skip” signal, the state machine 120 skips to the third power-down sequence state 424.

During the third power-down sequence state 424, the state machine 120 is structured to monitor for condition(s) (Cnd3C) (e.g., a positive edge of a standby_qual signal). However, the state machine 120 checks the value for the power-down sequence state 424 in the escape register set 202 of the escape circuitry 124. If the value for the power-down sequence state 424 is a first value (e.g., zero), the state machine 120 continues with normal operation. For example, if the condition occurs (e.g., CndCB=True), the state machine 120 transitions to the standby state 408 of FIG. 4A. However, if the value for the power-down sequence state 424 is a second value (e.g., one), the state machine 120 outputs an armed signal to the state machine escape circuitry 124. In this manner, the state machine escape circuitry 124 can monitor an additional or alternative condition than the first condition. After the state machine escape circuitry 124 determines that the additional or alternative has occurred, the state machine escape circuitry 124 can output a “continue” signal or a “skip” signal to the state machine 120 based on user/programmer/manufacturer/device commands. If the state machine escape circuitry 124 outputs the “continue” signal, the state machine 120 continues in the power-down sequence state 424 until the third condition is true. If the state machine escape circuitry 124 outputs the “skip” signal, the state machine 120 skips to the standby state 408 of FIG. 4A.

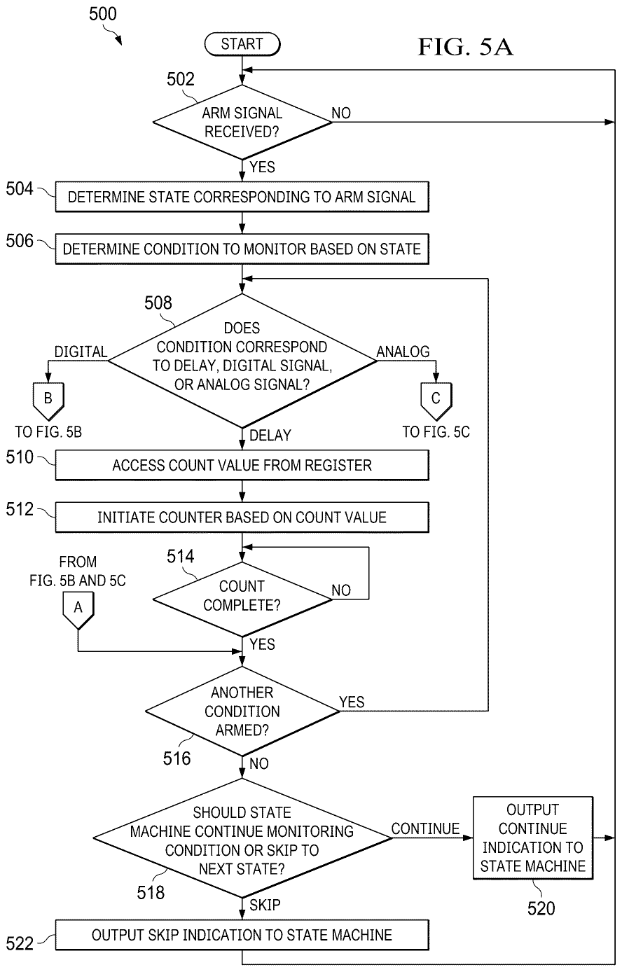

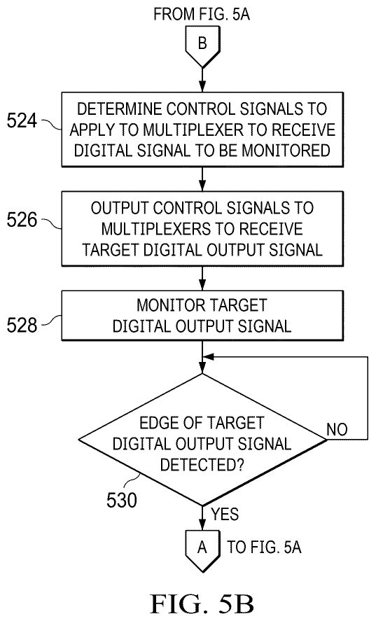

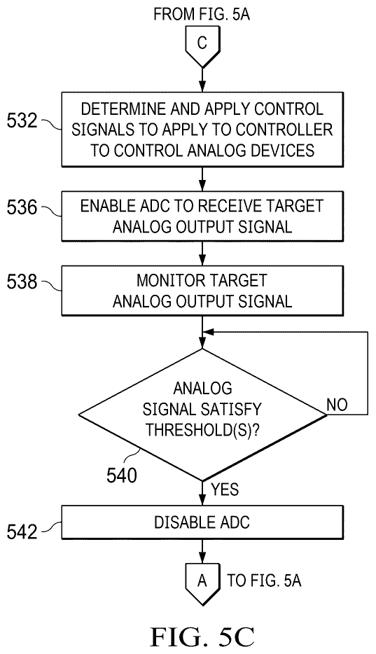

FIGS. 5A-5C illustrate a flowchart representative of a method and/or example operations 500 that may be executed and/or instantiated by the state machine escape circuitry 124 of FIGS. 1 and/or 2. The operations 500 can be performed by any one or combination of the circuitry shown in FIGS. 1 and/or 2. Although the instructions and/or operations of FIGS. 5A-5C are described in conjunction with the device 100 of FIGS. 1A and 1B, the state machine 120, and the state machine escape circuitry 124 of FIGS. 1A, 1B, and/or 2, the instructions and/or operations may be described in conjunction with any type of circuit that implements hardware and/or processing circuitry. Some processes shown in FIGS. 5A-5C may be performed in orders other than described, and many processes may be performed concurrently in parallel. Furthermore, processes shown in FIGS. 5A-5C may be omitted or substituted in some examples of the present description.

The machine-readable instructions and/or the operations 500 of FIGS. 5A-5C begin at block 502, at which the control circuitry 214 determines whether an “armed” signal has been set within the ‘armed’ bus from the state machine 120 via the interface circuitry 216. If the control circuitry 214 determines that the “armed” signal has not been obtained (block 502: NO), control returns to block 502. If the control circuitry 214 determines that the “armed” signal has been obtained (block 504: YES), the control circuitry 214 determines that state corresponding to the “armed” signal (e.g., the state that the state machine 120 is in) (block 504) by matching the armed signal bit position to the register bit position within the escape register set 202. At block 506, the control circuitry 214 determines a condition to monitor based on the determined state. For example, as described above, information identifying the condition to monitor for the state is stored in a set of registers in the registers 212 that correspond to the state to be repaired as selected within the register set 202. The control circuitry 214 can access the values in the registers 212 to determine which condition to first monitor (e.g., added delay, edge of a digital signal, or when analog signal satisfies a threshold) based on which ArmSlice N has been programmed for the register bit set within the escape register set 202.

At block 508, the control circuitry 214 determines whether the first condition corresponds to added delay, an edge of a digital signal or an analog signal satisfying a threshold. If the control circuitry 214 determines that the first condition corresponds to an edge/level of a digital signal (block 508: DIGITAL), control continues to block 524 of FIG. 5B, as further described below. If the control circuitry 214 determines that the first condition corresponds to an analog signal satisfying a threshold (block 508: ANALOG), control continues to block 532 of FIG. 5C, as further described below. If the control circuitry 214 determines that the first condition corresponds to added delay (block 508: DELAY), the control circuitry 214 accesses the count value from the “counter load value” register of the set of the registers 212 that correspond to the determined state (block 510). At block 512, the control circuitry 214 instructs the counter circuitry 206 to initiate a countdown (or count up) from the count value to zero (or from zero to the count value). When the count is complete, the counter circuitry 206 outputs a condition complete signal to the control circuitry 214.

At block 514, the control circuitry 214 determines if the count is complete based on whether the counter circuitry 206 has output a condition complete signal to the control circuitry 214. If the control circuitry 214 determines that the count is not complete (block 514: NO), control returns to block 514 until the count is complete. If the control circuitry 214 determines that the count is complete (block 514: YES), the control circuitry 214 determines whether another condition is armed for the state based on the values(s) stored in the “ArmChSlice Next” register(s) of the registers 212 (block 516). If the control circuitry 214 determines that another condition is armed (block 516: YES), control returns to block 508 to monitor the subsequent condition. If the control circuitry 214 determines that another condition is not armed (block 516: NO), the control circuitry 214 determines if the state machine 120 should continue to monitor the condition it was originally programmed to monitor before moving to a next state or if the state machine 120 should skip to a next state (block 518). For example, the control circuitry 214 accesses the value in the “continue/skip” register of the set of registers for the state to determine whether to output a “continue” or “skip” instruction.

If the control circuitry 214 determines that the state machine 120 should continue to monitor the condition (block 518: CONTINUE), the control circuitry 214 outputs the “continue” signal to the state machine 120 via the interface circuitry 216 (block 520) and control returns to block 502. If the control circuitry 214 determines that the state machine 120 should skip the condition (block 518: SKIP), the control circuitry 214 outputs the “skip” signal to the state machine 120 via the interface circuitry 216 (block 522) and control returns to block 502.

If the control circuitry 214 determines that the first condition corresponds to an edge/level of a digital signal (block 508: DIGITAL), the control circuitry 214 determines the control signals to apply the select terminals of the MUXs 112a-112c, 114, 126a-126c, 128 to obtain the digital signal to be monitored (block 524 of FIG. 5B). For example, the control circuitry 214 accesses the values stored in the “ULL_DTB,” “SVT_DTB,” and “IP_DTB” registers to determine how to control the MUXs 112a-112c, 114, 126a-126c, 128 to obtain the digital signal of interest. At block 526, the control circuitry 214 uses the interface circuitry 216 to output the control signals to the select terminals of the MUXs 112a-112c, 114, 126a-126c, 128. At block 528, the edge/level detection circuitry 208 monitors the digital signal output by the MUX 128 (e.g., the digital signal of interest). At block 530, the edge detection circuitry 208 214 determines if an edge/level (e.g., rising or falling edge depending on user/programmer/manufacturer/device preferences) of the target digital signal has been detected. The control circuitry 214 can instruct the edge/level detection circuitry 208 to output a condition complete signal based on detection of a rising edge or a falling edge or the right programmed level based on the value stored in the “PosEdge/NegEdge/Level” register. If the edge detection circuitry 208 determines that the edge of the target digital signal has not been detected (block 530: NO), control returns to block 530 until an edge is detected. If the edge detection circuitry 208 determines that the edge of the target digital signal has been detected (block 530: YES), control continues to block 516 of FIG. 5A. For example, the edge detection circuitry 208 outputs the condition complete signal to the control circuitry 214 and control returns to block 516 of FIG. 5A.

If the control circuitry 214 determines that the first condition corresponds to comparing an analog signal to a threshold (block 508: ANALOG), the control circuitry 214 determines and applies control signals to applies the controllers 118, 122 (block 532 of FIG. 5B). For example, the control circuitry 214 accesses the values stored in the “ATEST MUX,” “ANAIF TEST,” “PMCTL ATEST,” and “SYSCTL ATEST,” registers to determine how to instruct the controllers 118, 122 and/or the state machine 120 to cause a particular analog signal to be obtained by the ADC 116 and convert it to a digital signal to process. At block 536, the control circuitry uses the interface circuitry 216 to output a signal to the ADC 116 to enable the ADC 116. In some examples, if the ADC 116 is used for other purposes, the interface circuitry 216 can output a signal to gain control of the ADC 116.

At block 538, the comparator 210 monitors the target analog signal obtained from the ADC 116 via the interface circuitry 216. At block 540, the comparator 210 determines whether the monitored analog signal satisfies a threshold (e.g., defined in one or more of the ADC threshold registers of the registers 212). If the comparator 210 determines that the monitored analog signal does not satisfy the threshold (block 540: NO), control returns to block 540 until the monitored analog signal satisfies the threshold. If the comparator 210 determines that the monitored analog signal satisfies the threshold (block 540: YES), the comparator 210 outputs the condition complete signal to the control circuitry 214 and the control circuitry 214 disables the ADC 116 to conserve power (block 542). In some examples, the control circuitry 214 can relinquish control of the ADC 116 to another component. After block 542, control returns to block 516 of FIG. 5A.

An example manner of implementing the state machine escape circuitry 124 of FIGS. 1A and 1B is illustrated in FIG. 2. However, one or more of the elements, processes and/or devices illustrated in FIG. 2 may be combined, divided, re-arranged, omitted, eliminated, and/or implemented in any other way.

Further, the registers 202, 212, the condition monitoring circuitry 204, the counter circuitry 206, the edge/level detection circuitry 208, the comparator 210, the control circuitry 214, and/or the interface circuitry 216 of FIG. 2 may be implemented by hardware, software, firmware and/or any combination of hardware, software and/or firmware. As a result, for example, any the registers 202, 212, the condition monitoring circuitry 204, the counter circuitry 206, the edge detection circuitry 208, the comparator 210, the control circuitry 214, and/or the interface circuitry 216 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the registers 202, 212, the condition monitoring circuitry 204, the counter circuitry 206, the edge detection circuitry 208, the comparator 210, the control circuitry 214, and/or the interface circuitry 216 of FIG. 2 is/are hereby expressly defined to include a non-transitory computer readable storage device or storage disk such as a memory, a digital versatile disk (DVD), a compact disk (CD), a Blu-ray disk, etc., including the software and/or firmware. Further still, the registers 202, 212, the condition monitoring circuitry 204, the counter circuitry 206, the edge detection circuitry 208, the comparator 210, the control circuitry 214, and/or the interface circuitry 216 of FIG. 2 may include one or more elements, processes and/or devices in addition to, or instead of, those illustrated in FIG. 2, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Flowcharts representative of example hardware logic, machine-readable instructions, hardware implemented state machines, and/or any combination thereof for implementing the state machine escape circuitry 124 of FIG. 2 are shown in FIGS. 5A-5C. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowcharts illustrated in FIGS. 5A-5C, many other methods of implementing the state machine escape circuitry 124 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, a field-programmable gate array (FPGA), an application-specific integrated circuit (ASIC), a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example processes of FIG. 3 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The term “couple” “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple,” “coupled,” “couples,” or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-2, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal,” “node,” “interconnect,” “pad,” and “pin” may be used interchangeably.

The terms “or” and “and/or” as used, for example, in a form such as A, B, or C or A, B, and/or C refers to any combination or subset of A, B, C such as (1) A alone, (2) B alone, (3) C alone, (4) A with B, (5) A with C, (6) B with C, or (7) A with B and with C.

Example methods, apparatus, systems, and articles of manufacture to a modification of a condition for a state machine transition are disclosed herein. Further examples and combinations thereof include the following: Example 1 includes a device comprising a first circuit configurable to transition from a first state to a second state when a first signal is asserted, and a second circuit configurable to modify a condition of the transition from the first state to the second state in the second circuit based on a command received from an interface.

Example 2 includes the device of example 1, wherein the second circuit is configurable to select a delay using the command, and impose the delay on the first circuit when the first circuit is transitioning from the first state to the second state.

Example 3 includes the device of example 1, wherein the second circuit is configurable to select a second signal using the command, and cause the first circuit to delay the transition from the first state to the second state until the second signal is asserted.

Example 4 includes the device of example 1, wherein the second circuit is configurable to select a second signal using the command, and cause the first circuit to delay the transition from the first state to the second state until the second signal satisfies a threshold value.

Example 5 includes the device of example 4, wherein the second circuit is configurable to select the threshold value using the command.

Example 6 includes the device of example 1, wherein the first state and the second state are part of a power-up sequence or a power-down sequence of the first circuit.

Example 7 includes the device of example 1, wherein the command is a first command, further comprising a third circuit configurable to transition from a third state to a fourth state when a second signal is asserted, wherein the second circuit is configurable to modify the transition from the third state to the fourth state in the third circuit in response to a second command received from the interface.

Example 8 includes the device of example 1, wherein the command is a first command, wherein the first circuit is configurable to transition from a third state to a fourth state when a second signal is asserted, and wherein the second circuit is configurable to modify the transition from the third state to the fourth state in the first circuit in response to a second command received from the interface.

Example 9 includes the device of example 1, further comprising a plurality of circuits, wherein each circuit of the plurality of circuits is configurable to perform state transitions, and wherein the second circuit is configurable to modify the state transitions performed by the plurality of circuits.

Example 10 includes the device of example 1, further comprising the interface configurable to receive the command from an external programmer device.

Example 11 includes a device comprising a first circuit configurable to transition from a first state to a second state based on an occurrence of a first event, and a second circuit configurable to, based on a value stored in a register determine an occurrence of a second event different from the first event, and cause the first circuit to transition from the first state to the second state based on the occurrence of the second event.

Example 12 includes the device of example 11, wherein the second circuit is configurable to prevent the first circuit from transition from the first state to the second state until the occurrence of the second event.

Example 13 includes the device of example 11, wherein the second circuit is configurable to prevent the first circuit from transition from the first state to the second state until the occurrence of the second event and the occurrence of the first event.

Example 14 includes the device of example 11, wherein the value is stored in the register based on a command received from an interface from an external programmer.

Example 15 includes the device of example 11, wherein the second event corresponds to an amount of delay.

Example 16 includes the device of example 11, wherein the occurrence of the second event corresponds to an edge/level of a digital signal.

Example 17 includes the device of example 11, wherein the occurrence of the second event corresponds to an analog signal satisfying a threshold.

Example 18 includes a system comprising a first circuit configurable to access (a) a first value for transitioning from a first state to a second state based on a first event and (b) a second value for transitioning from the second state to a third state based on a second event, and based on the first value and an occurrence of the first event, transition from the first state to the second state, based on the second value, outputting a condition complete signal, a second circuit configurable responsive to the condition complete signal, determining a third event to monitor, the third event different than the second event, and transmit a response to the first circuit based on an occurrence of the third event, and the first circuit configurable to one of (a) transition from the second state to the third state based on reception of the response or (b) transition from the second state to the third state based on (i) a detection of the second event and (ii) reception of the response.

Example 19 includes the system of example 18, wherein the second circuit is configurable to determine the occurrence of the third event by determining that an amount of delay has occurred, detecting of an edge/level of a digital signal, or detecting when an analog signal satisfies a threshold.

Example 20 includes the system of example 18, wherein the first state, the second state, and the third state are part of a power-up sequence or a power-down sequence of the first circuit.

Modifications are possible in the described embodiments, and other embodiments are possible, within the scope of the claims.

What is claimed is:

1. A device comprising:
a first circuit configurable to transition from a first state to a second state when a first signal is asserted; and
a second circuit configurable to modify a condition of the transition from the first state to the second state in the second circuit based on a command received from an interface.

2. The device of claim 1, wherein the second circuit is configurable to:
select a delay using the command; and
impose the delay on the first circuit when the first circuit is transitioning from the first state to the second state.

3. The device of claim 1, wherein the second circuit is configurable to:
select a second signal using the command; and
cause the first circuit to delay the transition from the first state to the second state until the second signal is asserted.

4. The device of claim 1, wherein the second circuit is configurable to:
select a second signal using the command; and
cause the first circuit to delay the transition from the first state to the second state until the second signal satisfies a threshold value.

5. The device of claim 4, wherein the second circuit is configurable to select the threshold value using the command.

6. The device of claim 1, wherein the first state and the second state are part of a power-up sequence or a power-down sequence of the first circuit.

7. The device of claim 1, wherein the command is a first command, further comprising a third circuit configurable to transition from a third state to a fourth state when a second signal is asserted,
wherein the second circuit is configurable to modify the transition from the third state to the fourth state in the third circuit in response to a second command received from the interface.

8. The device of claim 1, wherein the command is a first command,
wherein the first circuit is configurable to transition from a third state to a fourth state when a second signal is asserted, and
wherein the second circuit is configurable to modify the transition from the third state to the fourth state in the first circuit in response to a second command received from the interface.

9. The device of claim 1, further comprising a plurality of circuits,
wherein each circuit of the plurality of circuits is configurable to perform state transitions, and
wherein the second circuit is configurable to modify the state transitions performed by the plurality of circuits.

10. The device of claim 1, further comprising the interface configurable to receive the command from an external programmer device.

11. A device comprising:
a first circuit configurable to transition from a first state to a second state based on an occurrence of a first event; and
a second circuit configurable to, based on a value stored in a register:
determine an occurrence of a second event different from the first event; and
cause the first circuit to transition from the first state to the second state based on the occurrence of the second event.

12. The device of claim 11, wherein the second circuit is configurable to prevent the first circuit from transition from the first state to the second state until the occurrence of the second event.

13. The device of claim 11, wherein the second circuit is configurable to prevent the first circuit from transition from the first state to the second state until the occurrence of the second event and the occurrence of the first event.

14. The device of claim 11, wherein the value is stored in the register based on a command received from an interface from an external programmer.

15. The device of claim 11, wherein the second event corresponds to an amount of delay.

16. The device of claim 11, wherein the occurrence of the second event corresponds to an edge of a digital signal.

17. The device of claim 11, wherein the occurrence of the second event corresponds to an analog signal satisfying a threshold.

18. A system comprising:
a first circuit configurable to:
access (a) a first value for transitioning from a first state to a second state based on a first event and (b) a second value for transitioning from the second state to a third state based on a second event; and
based on the first value and an occurrence of the first event, transition from the first state to the second state;
based on the second value, outputting a condition complete signal;
a second circuit configurable to:
responsive to the condition complete signal, determining a third event to monitor, the third event different than the second event; and
transmit a response to the first circuit based on an occurrence of the third event; and
the first circuit configurable to one of (a) transition from the second state to the third state based on reception of the response or (b) transition from the second state to the third state based on (i) a detection of the second event and (ii) reception of the response.

19. The system of claim 18, wherein the second circuit is configurable to determine the occurrence of the third event by determining that an amount of delay has occurred, detecting of an edge of a digital signal, or detecting when an analog signal satisfies a threshold.

20. The system of claim 18, wherein the first state, the second state, and the third state are part of a power-up sequence or a power-down sequence of the first circuit.
